(19) United States
(12) Patent Application Publication
(10) Pub. No.: US 2024/0081353 A1
(43) Pub. Date: Mar. 14, 2024

(54) COCONUT DOUGH TO MAKE TORTILLAS

(71) Applicants: Luca PORRINO PERASSI, Santiago (MX); María José MACIAS LOPEZ, Santiago (MX)

(72) Inventors: Luca PORRINO PERASSI, Santiago (MX); María José MACIAS LOPEZ, Santiago (MX)

(21) Appl. No.: 18/182,501

(22) Filed: Mar. 13, 2023

(30) Foreign Application Priority Data
Sep. 14, 2022 (MX) A/2022/011433

(51) Int. Cl. A21D 13/04; A21D 2/16; A21D 2/18; A21D 2/26; A21D 13/42

(52) U.S. Cl. CPC A21D 13/04; A21D 2/165; A21D 2/181; A21D 2/183; A21D 2/186; A21D 2/262; A21D 13/42

(57) ABSTRACT

Disclosed is a formula to produce gluten free coconut dough, in addition to other ingredients to produce a paste, which may be used to make products such as tortillas, chips, tostadas and dough to make tamales, and others, being gluten free, to be consumed by celiac individuals. This compound includes coconut flour, gluten free, saturated fat, fiber and proteins, which are good for health, in which the coconut pulp is obtained after ex-tracting the milk, and desiccated at low temperature to make tortillas and other products. The coconut flour contains 18% of protein, 14% of saturated fat and a reduced amount of carbohydrates.

### CROSS-REFERENCE TO RELATED APPLICATIONS

Not applicable.

### BACKGROUND OF THE INVENTION

### 1. Field of the Invention

The invention describes a formula made from gluten-free coconut flour, in addition to other ingredients to create a dough, which may be used to prepare tortillas, chips, tostadas (dough to make tamales) made from coconut flour, thereby becoming a specialized formula, difficult to replicate, accompanied by all the benefits listed below.

### 2. Description of Related Art Including Information Disclosed Under 37 CFR 1.97 And 37 CFR 1.98

A corn tortilla is a round flat food made from processed corn, which is powdered, made into dough and cooked on a flat griddle. Tortillas are present in all Mexican homes, and accompanies most Mexican dishes, being ever-present.

With an unknown origin, several versions indicate that it comes from the region of the State of Tlaxcala, which means “the place of corn or the place of tortillas”. Celiac disease has been on the rise for the past 25 years, which causes inflammation of the small intestine due to difficulties in the digestion of gluten, which is present in various cereals like wheat, rye or barley.

Wherefore, many foods are currently gluten-free. However, there are very few products that replace flours made from the aforementioned cereals.

Gluten-free food represents an alternative for all the people looking to have a healthier diet. Several studies indicate that gluten is protein present in wheat and its variants, with viscous properties, elasticity and spongy consistency. However, the quality of the gluten protein is low, as it lacks essential amino acids.

One of the novel benefits of gluten-free coconut flour is that it can be easily kneaded with a rod or any other cooking utensil to make dough.

Gluten-free coconut flour is not currently available in the market, which may be kneaded without adding an additional product, such as yeast, salt, oil or any other. The consistency of the dough is resistant and doesn't break, being light and thin. Its consistency is similar to wheat-based dough, but with a white color, being made from coconut. There is no coconut-based flour currently in the market which is similar to wheat-based flour and is gluten-free.

### BRIEF SUMMARY OF THE INVENTION

The invention describes a formula made from gluten-free coconut flour, in addition to other ingredients to create a dough, which may be used to prepare tortillas, chips, tostadas (dough to make tamales) made from coconut flour, thereby becoming a specialized formula, difficult to replicate, accompanied by all the benefits listed below.

The dough is easy to knead and only requires water. Several tests have been conducted using industrial kneading machines with any inconvenience. Mixing time varies depending on the power of the kneading machine. Another additional benefit is that waste has been reduced to a minimum due to the dough's malleability and consistence.

This food product is made from gluten-free coconut flour, comprising saturated fats, fiber and protein, which are good for human health. Coconut flour is obtained after extracting the milk, desiccated at a low temperature; thereby obtaining a soft flour with nutritional properties, which may be used in preparations to make flour-based foods.

This coconut flour has a typical content of at least 18% of protein, 14% saturated fat and less carbohydrates. By making tortillas with this innovative food compound, several tests have been carried out in different tortilla making machines with no inconvenience.

The characteristic taste of tortilla is a soft mixture of yeast (bread) and coconut.

From a nutritional perspective, one of the most appealing advantages of this innovative product, is the nutrition facts, as 100 grams of flour have almost 13 grams of high-fiber protein and only 43 grams of sodium, which makes it a source of fiber and protein, gluten-free, with a minimum amount of sugar, making it an excellent product for people with celiac disease, diabetes and/or obesity, being made mostly from coconut; thereby preserving all the intrinsic health benefits of coconut.

Our flour to make tortillas does not contain any type of preservative. However, once the tortillas have been prepared under adequate innocuous conditions, they may remain frozen for 12 months, 3 months in refrigeration and 30 days in a fresh and dry environment.

### Advantages of the Invention

The invention refers to gluten-free flour to make tortillas and similar products, which undoubtedly represents a great alternative for all the individuals looking for healthier food options. Recent research shows that gluten is a protein present in wheat and similar grains, with viscous properties, elasticity and spongy consistency.

Currently, various healthcare professionals recommend a low consumption of gluten in our everyday diet, which may provide clear health benefits, such as low blood pressure, reduction in cholesterol levels and triglycerides; thereby reducing the risk of suffering thrombosis or strokes and losing weight.

Therefore, the purpose of the present invention is having coconut flour, obtained from gluten-free materials, which may be easily digested by any person.

Another advantage of the present invention is that once the mix has been prepared, it may be kneaded in a simple manner, with the hands or using any other cooking utensil.

Another objective of the present invention is having coconut flour which may be made without adding any additional product, such as yeast, salt, oil or any other, being highly malleable. This product may be easily kneaded, as it only needs water, and additionally, waist is reduced, due to the consistency and malleability of the dough.

The flavor is different from the characteristic flavor of tortillas, it is a mixture of yeast (bread) and coconut.

### DETAILED DESCRIPTION OF THE INVENTION

The production of tortillas, chips, tostadas and dough to make tamales made from gluten-free coconut flour, becoming an alternative for people looking for healthier food options. Gluten is a protein present in wheat and similar grains, with viscous properties, elasticity and spongy consistency.

Coconut flour is gluten free and the formula has the novelty of not being present in any product currently present in the market, such as cereal-based flours, as the formula of the present invention only requires water.

In regard to the preparation process, gluten free coconut flour is made from coconut, extracting oil and dried at a low temperature between 4 and 10 degrees Celsius.

Once the raw material has been dried, it is powdered and grinded to make flour of soft consistency and white color, which is gluten free.

This formula proposed to make tortillas, tostadas, chips and dough to make tamales is a mix of gluten free coconut flour and other ingredients, creating a fortified paste, containing (percentage by weight):

| | |
|---|---|
| Coconut Flour | 52.94% |
| Rice Flour | 14.50% |
| Corn Starch | 14.50% |
| Powdered Sugar | 4.50% |
| Psyllium | 2.00% |
| Dextrose Monohydrate | 2.00% |
| Oil | 4.20% |
| Vegetable Oil | 1.80% |
| Xanthan Gum | 1.50% |
| Modified Corn Starch | 7.00% |
| Egg Albumin | 1.30% |
| Yeast | 0.40% |
| Whey | 2.00% |
| Coloring | 0.012% |
| TOTAL | 100% |

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. Coconut dough to make tortillas, comprising the extraction of oil from coconut, dried at a temperature between 4 to 10 degrees Celsius; once the raw material has been dried, it is powdered to make flour with soft consistency, which is gluten free by nature.

2. Coconut dough to make tortillas of claim 1, comprising, by weight:

| | |
|---|---|
| Coconut Flour | 52.94% |
| Rice Flour | 14.50% |
| Corn Starch | 14.50% |
| Powdered Sugar | 4.50% |
| Psyllium | 2.00% |
| Dextrose Monohydrate | 2.00% |
| Oil | 4.20% |
| Vegetable Oil | 1.80% |
| Xanthan Gum | 1.50% |
| Modified Corn Starch | 7.00% |
| Egg Albumin | 1.30% |
| Yeast | 0.40% |
| Whey | 2.00%; and |
| Coloring | 0.012%. |
